(19) United States
(12) Patent Application Publication
(10) Pub. No.: US 2014/0255722 A1
(43) Pub. Date: Sep. 11, 2014

(54) STRUCTURAL MULTI-LAYER COBALT COATINGS FOR POLYMER ARTICLES

(71) Applicant: Integran Technologies Inc., Mississauga (CA)

(72) Inventors: Nandakumar Nagarajan, Burlington (CA); Mioara Neacsu, Maple (CA); Gino Palumbo, Toronto (CA); Klaus Tomantschger, Mississauga (CA)

(73) Assignee: Integran Technologies Inc., Mississauga (CA)

(21) Appl. No.: 13/786,495

(22) Filed: Mar. 6, 2013

(51) Int. Cl. C09D 1/00

(52) U.S. Cl. CPC C09D 1/00
USPC 428/626; 428/457; 428/339; 205/50; 428/462

(57) ABSTRACT

Corrosion resistant, grain-refined and/or amorphous Ni- and Cu-free Co-bearing coatings on polymer substrates for use in human contact applications, including industrial products, automotive products, medical surgical devices, and medical products, are disclosed.

### FIELD OF THE INVENTION

The invention relates to multi-layered cobalt-coatings, free of nickel and copper as corrosion-resistant structural coatings on polymer articles which are ideally suited for human contact applications, including consumer products, industrial products, automotive products, medical surgical devices, and hospital equipment. The invention can also be applied to polymer products for exterior or interior environments without the necessity of covering copper layers with multiple layers of nickel and with chromium to prevent the parts from corroding.

### BACKGROUND OF THE INVENTION

Polymers (including thermoplastics, themosets and elastomers) are coated with metal layers for two broad classes of applications, namely, a) decorative, and b) functional. Plated polymer articles for decorative purposes include toys, shoes, bathroom fixtures, lamp parts, candlesticks, door knobs, buckles, sports articles such as bike handles, interior automotive parts such as door handles, trim, logos, etc., and decorative surfaces of household appliances. The consumer electronic industry uses nickel-chrome plated articles for decorative purposes. Usually, these parts are required to have a high gloss finish with good thermal cycling and corrosion resistance. Conventional plating processes for such articles involves pre-plating the polymer substrate with electroless nickel, and applying a highly leveling Cu layer to achieve a very smooth surface finish, over which multi-layers of Ni are added for the corrosion protection of Cu, followed by a Cr layer for tarnish resistance.

Functional plating on polymer components is less prevalent as compared to decorative plating. Exterior automotive applications require plated polymer articles meeting stringent thermal cycling and corrosion specifications and therefore demand higher plating layer thicknesses. The electronics industry, especially the printed circuit board (PCB) industry, uses metal-coated polymer components widely with electroless Cu or Ni pre-plating layers as the polymer metalization layers, and highly conductive copper, nickel, silver or gold plated layers. The medical industry used plated polymers to a lesser degree, with a few instances of use in instruments, surgical devices and the like. Conventional plating processes, involving Ni over-layers and Cu under-layers, are unsuited for the medical device industry for two reasons: a) Ni is a known sensitizer/allergen to the human body, hence its use is highly restricted unless it is in an alloy form which prevents its release through leaching in body fluids. Cu is a known cytotoxin and is therefore avoided in the medical device industry.

The prior art describes numerous processes for metalizing and plating polymers for a number of the above mentioned applications.

Buckman in U.S. Pat. No. 3,501,332 (1970) describes one of the earliest process for metal plating on polymer articles, disclosing a novel sensitizing method for forming a conductive electroless Ni layer on thermoplastic substrates.

Shirahata et al. in U.S. Pat. No. 4,128,691 (1978) describe a process for producing magnetic recording media thin metal film by electroless plating in an aqueous solution containing at least one ferromagnetic metal ion, barium ion and hypophosphite ion as a reducing agent, and thus forming a magnetic film.

Chebiam et al. in US 2004/0096592 describe an electroless Co process with least one reducing agent, and an ammonia-free complexing/buffering agent (such as glycine, triethanolamine, and tris(hydrozymethyl)(aminoethane). The electroless Co plating solution is used in the fabrication of a variety of structures including copper diffusion barriers and silicide contacts in the manufacture of microelectronic devices.

Hurley in U.S. Pat. No. 3,868,229 (1976) discloses a process for a decorative nickel chrome coating on ABS wherein the plated polymer is characterized by good appearance, excellent resistance to thermal cycling and to corrosive media. While the disclosed process avoids the use of an underlying Cu layer, the plated polymer does not provide any enhanced structural properties.

Leech in U.S. Pat. No. 4,054,693 (1977) discloses processes for the activation of resinous materials with a composition comprising water, permanganate ion and manganate ion at a pH in the range of 11 to 13 exhibiting superior peel strengths following electroless metal deposition.

Stevenson in U.S. Pat. No. 4,552,626 (1985) describes a process for metal plating filled thermoplastic resins such as Nylon-6®. The filled resin surface to be plated is cleaned and rendered hydrophilic and preferably deglazed by a suitable solvent or acid. At least a portion of the filler in the surface is removed, preferably by a suitable acid. Thereafter, electroless plating is applied to provide an electrically conductive metal deposit followed by depositing at least one metallic layer by electroplating to provide a desired wear resistant and/or decorative metallic surface.

Donovan et al. in U.S. Pat. No. 6,468,672 (2002) also disclose a decorative chromium plating process on a polymer substrate, which provides a lustrous decorative finish with enhanced thermal cycling and corrosion resistance characteristics without a Cu sublayer, but providing no structural enhancements compared with the bare polymer.

Yates et al. in U.S. Pat. No. 5,863,410 (1999) describe an electrolytic process for producing Cu foil having a matte surface with micropeaks with a height not greater than about 200 microinches (˜5 microns) exhibiting a high peel strength when bonded to a polymeric substrate.

Various patents address the fabrication of articles for a variety of applications:

Helmus et al. in US 2008/0102194 disclose methods for coating surfaces of medical devices by electroless plating, with the plating material incorporating a therapeutic agent.

Birdsall et al. in US 2005/0092615 disclose metallic composite coatings on implantable devices with the coatings incorporating therapeutic agents that are delivered by the implantable device.

Lye et al. in U.S. Pat. No. 7,294,409 (2007) disclose medical devices with porous metallic layers with these layers containing therapeutic agents for delivery into the human body.

Ogle et al. in U.S. Pat. No. 6,322,588 (2001) disclose medical devices formed from metal/polymer composites with a relative thick metal coating of greater than 3 microns which provides durability, strength and resiliency.

Erb et al. in U.S. Pat. No. 5,352,266 (1994), and U.S. Pat. No. 5,433,797 (1995), assigned to the same applicant as the present application, describe a process for producing nanocrystalline materials, particularly nanocrystalline nickel. The nanocrystalline material is electrodeposited onto the cathode in an aqueous electrolyte by application of a pulsed current.

Palumbo et al. in U.S. Pat. No. 7,354,354 (2008), assigned to the same applicant as the present application, disclose lightweight articles comprising a polymeric material at least partially coated with a fine-grained metallic material. The fine-grained metallic material has an average grain size of 2 nm to 5,000 nm, a thickness between 25 micron and 5 cm, and a hardness between 200 VHN and 3,000 VHN. The lightweight articles are strong and ductile and exhibit high coefficients of restitution and a high stiffness and are particularly suitable for a variety of applications including aerospace and automotive parts, sporting goods, and the like.

Wang et al. in US 2012/0237789, assigned to the same applicant as the present application, disclose high yield strength metal-polymer articles where the metallic materials cover at least part of a surface of the polymeric materials. The metallic material has a microstructure which, at least in part, is fine-grained with an average grain size between 2 and 5,000 nm and amorphous.

Elia et al, in U.S. Pat. No. 8,367,170 (2013), assigned to the same applicant as the present application, disclose a vehicular electrical or electronic housing comprising an organic polymer coated at least in part by a metal, wherein the metal coated polymer has a flexural modulus at least twice that of the uncoated polymer part.

Elia et al. in US 2010/0239801, assigned to the same applicant as the present application, disclose a structural member for hand held devices such as cell phones, comprising of a synthetic resin composition which is covered in part by a metal.

Tornantschger et al. in US 2009/0159451, assigned to the same assignee as the present application, discloses variable property deposits (graded and/or layered) of fine-grained and amorphous metallic materials, optionally containing solid particulates, on a variety of substrates for a number of applications.

Tomantschger et al, in US 2010/0304197, assigned to the same assignee as the present application, describe metal-clad polymer articles containing structural fine-grained and/or amorphous metallic coatings/layers optionally containing solid particulates dispersed therein. The metallic coatings are particularly suited for strong and lightweight articles exposed to thermal cycling although the coefficient of linear thermal expansion of the metallic layer and the substrate are mismatched.

Facchini et al, in U.S. Pat. No. 8,309,233 (2012) and in US 2010/0304065, assigned to the same assignee as the present application, disclose free standing articles or articles at least partially coated with substantially porosity free, fine-grained and/or amorphous Co-hearing metallic materials optionally containing solid particulates dispersed therein. The electrodeposited metallic layers and/or patches comprising Co provide, enhance or restore strength, wear and/or lubricity of substrates without reducing the fatigue performance.

### SUMMARY OF THE INVENTION

The focus of the present disclosure is to provide, beyond unavoidable impurities, metallic coatings comprising Co which are Ni-free and/or Cu-free for polymeric substrates that can be used to fabricate articles in a wide range of applications, including but not limited to automotive, aerospace, medical, defense, consumer goods, sporting articles and the like. The main advantages of using Co-bearing metallic coatings and eliminating Cu as the underlying layer in plated polymers are the following:
(i) The absence of Cu as one of the intermediate layers in the metal-plated polymer article completely eliminates the problem of Cu corrosion products, i.e., Cu appearing on the outer surface if the overlying nickel layers are breached by scratches, pits, cracks, and the like.
(ii) Cu is a known cytotoxin to human cells, thus, for medical devices containing plated polymers where Cu is the underlying layer, it is imperative to prevent the potential leaching of Cu when exposed to body fluids. As there is always a risk of Cu leaching out, it is better to totally avoid the use of Cu as an underlying layer for medical devices.
(iii) Multiple layers of Ni on the plated polymer, necessitated by the use of Cu as the intermediate layer, can be avoided if the employ of a Cu layer can be eliminated providing a huge benefit in product weight, process cost, and thus, product cost.

The main advantages using Co-bearing metallic coatings which are Ni-free on plated polymers are as follows:
(iv) The absence of nickel layers either as intermediate layers, or as structural layers, eliminates the problem of nickel sensitization when the plated article comes in contact with human skin.

Ni- and Cu-free in this context is defined as having no Ni- and Cu-bearing materials added, and the total “unavoidable impurity level” of Ni and/or Cu in the Co-comprising metallic layer(s) is less than 1%, preferably less than 0.5% and more preferably less than 0.1%.

The present invention discloses a Co-based metalization layer that eliminates the need for the electroless nickel layers, and Co-based single or multiple layer metallic coatings eliminating the need for Cu underlayers, or nickel overlayers. The present invention discloses a new process and method of making articles containing “no added” Ni or Cu, which can be used without any health concerns relating to Ni sensitization, Cu corrosion, or Cu cytotoxicity.

One main objective of the invention is to provide a process to form an electrolytically deposited Co or Co alloy metallic coating on a polymer substrate rendered conductive through an intermediate electroless Co deposition layer, also termed intermediate structure or metalizing layer, which avoids the use of any Cu or Cu corrosion products on the article on which the coatings are applied.

Another main objective of the invention is to provide a process to form, on articles that come in contact with human skin, or human tissue, an electrolytically deposited Co or Co alloy metallic coating, over an electroless Co deposited layer on a polymer substrate, which will avoid any Ni sensitization issues, or Cu cytotoxicity issues.

Another objective of the invention is to provide a process to pre-treat the polymer substrate suitably to apply an adherent electroless Co metalization layer on the polymer substrate with a maximum thickness of the intermediate structure of 10 μm, preferably 5 μm and more preferably 2.5 μm.

Another objective of the present invention is to provide an electroless Co deposition process that provides equal or better adhesion strength to a wide range of polymer substrates specified in the disclosure.

Another objective of the present invention is to provide an electroless Co metalization process that is able to achieve better selectivity with respect to platable and non-platable polymers present in, e.g., a two-shot molded article.

Another objective of the invention to provide a Co or Co alloy metallic coating/layer on the electroless Co metalization layer, selected from the group of amorphous, fine-grained and coarse-grained Co, Co alloys and Co containing, Ni- and Cu-free, metal matrix composites. The metallic coating/layer is applied to the polymer substrate by a suitable metal deposition process. Preferred metal deposition processes include low temperature processes, i.e., processes operating below the softening and/or melting temperature of the polymer substrates, selected from the group of electroless deposition, electrodeposition, physical vapor deposition (PVD), chemical vapor deposition (CVD) and gas condensation. Alternatively, the polymer can be applied to a metallic layer. The metallic material represents between 1 and 95% of the total weight of the article, preferably between 5 and 95% of the total weight of the article.

It is an objective of the present invention to provide Co-bearing single or multi-structural, Ni- and Cu-free, metallic layers or multi-layers having a microstructure selected from the group of fine-grained, amorphous, graded and layered structures, which have a total metallic layer thickness in the range of between 1 μm and 5 cm, preferably between 5 μm and 2.5 mm, preferably between 10 μm and 1 mm, and more preferably between 25 μm and 500 μm.

It is an objective of the invention to provide a metal-clad polymer article comprising a shaped or molded polymer component comprising polymeric resins or polymeric composites including, but not limited to, epoxies, ABS, polypropylene, polyethylene, polystyrene, vinyls, acrylics, polyamide and polycarbonates. Suitable fillers include carbon, ceramics, oxides, carbides, nitrides, polyethylene, fiberglass and glass in suitable forms including fibers and powders.

It is another objective of the invention to provide laminate articles, e.g., a metal-clad polymer article, exhibiting no delamination and the displacement of said metallic material relative to the polymeric material or relative to any intermediate layer being less than 2% after said articles have been exposed to at least one temperature cycle according to ASTM B553-71 service condition 1, 2, 3 or 4 and exhibiting a pull-off strength between the polymeric material and the metallic material or between any intermediate layer(s) and the metallic material exceeding 200 psi as determined by ASTM D4541-02 method A-E.

It is an objective of the invention to provide metal-polymer articles with a multi-layer metallic coating comprising Co throughout the entire multi-layer metal coating cross section which has a highly smooth outer surface finish, with maximum surface roughness Rₐ or R_{y} of 5 μm, preferably 2 μm, more preferably 1 μm, more preferably 0.25 μm, and even more preferably 0.1 μm. In the context of this application the average surface roughness Rₐ is defined as the arithmetic means of the absolute values of the profile deviations from the mean line and Ry (Ryₘₐₓ according to DIN) is defined as the distance between the highest peak and the lowest valley of the interface surface.

It is an objective of the invention to apply a fine-grained and/or amorphous Co-bearing Ni-free and Cu-free metallic coating to at least a portion of the surface of a part made substantially of polymer(s) and/or glass fiber composites and/or carbon/graphite fiber composites including carbon fiber/epoxy composites, optionally after metallizing the surface (layer thickness ≦5 μm, preferably ≦2.5 μm, preferably 1-2 μm) with a thin layer of electroless Co for the purpose of enhancing the electrical conductivity of the substrate surface. The fine-grained and/or amorphous Ni-free, Cu-free Co-bearing coating is always substantially thicker (≧10 micron) than the metallizing layer.

According to this invention patches or sleeves which are not necessarily uniform in thickness can be employed in order to, e.g., enable a metallic thicker coating on selected sections or areas of articles particularly prone to heavy use such as in the case of selected medical and automotive components, sporting goods, consumer products, electronic devices and the like.

It is an objective of the invention to achieve adhesion strength as measured using ASTM D4541-02 Method A-E “Standard Test Method for Pull-Off Strength of Coatings Using Portable Adhesion Testers” between the metallic material/coating and the polymer material/substrate which exceeds 200 psi, preferably 300 psi, preferably 500 psi and more preferably 600 psi and up to 6,000 psi.

It is an objective of the invention to improve the adhesion between the polymeric substrate and the Ni-free, Cu-free Co-bearing metallic layer by a suitable heat treatment of the metal-clad article for between 5 minutes and 50 hours at between 40 and 200° C.

It is an objective of this invention to provide articles with Co-bearing fine-grained and/or amorphous metallic coatings, which are Ni-free and Cu-free, on composite polymeric substrates capable of withstanding at least 1, preferably at least 5, more preferably at least 10, more preferably at least 20 and even more preferably at least 30 temperature cycles without failure according to ANSI/ASTM specification B604-75 section 5.4 (Standard Recommended Practice for Thermal Cycling Test for Evaluation of Electroplated Plastics ASTM B553-71) for service condition 1, preferably service condition 2, preferably service condition 3 and even more preferably for service condition 4.

It is an objective of this invention to provide articles composed of fine-grained and/or amorphous metallic, Co-bearing Ni-free and Cu-free coatings, and having a top layer of, e.g., thin dense Cr or Cr, on composite polymeric substrates capable of withstanding at least 6 hrs, preferably at least 12 hrs, more preferably at least 22 hrs, more preferably at least 48 hrs, and even more preferably at least 96 hrs of exposure to the Copper Accelerated Salt Spray (CASS) test, according to ASTM B368, without any indication of corrosion of the underlying layers.

It is an objective of this invention to provide articles composed of fine-grained and/or amorphous metallic, Co-bearing Ni-free and Cu-free coatings, and top/outer-surface coatings selected from the group consisting of polymeric coatings such as Paralyene®, DLC (diamond like carbon) PVD (physical vapor deposition) coatings, metal coatings, nitride coatings, carbide coatings, oxide coatings, and biocompatible coatings such as hydroxyapatite (HAP).

It is an objective of this invention to provide lightweight polymer/metal-hybrid articles with increased strength, stiffness, durability, wear resistance, thermal conductivity and thermal cycling capability.

It is an objective of this invention to provide polymer articles, coated with fine-grained and/or amorphous metallic layers that are stiff, lightweight, resistant to abrasion, resistant to permanent deformation, do not splinter when cracked or broken and are able to withstand thermal cycling without degradation, for a variety of applications including, but not limited to: (i) applications requiring cylindrical objects including gun barrels, shafts, tubes, pipes and rods, golf and arrow shafts, skiing and hiking poles, fishing poles, baseball bats, bicycle parts including frames, wires and cables, and other cylindrical or tubular structures for use in commercial goods; (ii) medical and surgical equipment such as scissors, forceps, needle holders, hand-held and self-retaining retractors, scalpels, towel clamps, bone cutters, bone files and rasps, bone saw guides, drill adaptors, k-wires, guide wires, nerve hooks, pliers, sleeves, skin hooks, suction tubes, suture passers, tension devices, orthopaedic surgical instruments, endosurgical devices, surgical staplers, surgical cutters, staples, staple surfaces, splints, patient supports, orthopedic prosthesis and implants medical consumer items such as wheel chairs, crutches, hearing aid components, eyewear components, hospital equipment, etc.; (iii) sporting goods including golf shafts, heads and faceplates, lacrosse sticks, hockey sticks, skis and snowboards as well as their components including bindings, racquets for tennis, squash and badminton; (iv) components and housings for electronic equipment including laptops, TVs and handheld devices including cell phones, personal digital assistants (PDAs) devices, MP3 players, smart phones such as BlackBerry®-type devices, digital cameras and other image recording devices; (v) automotive components including cabin components including seat parts, steering wheel and armature parts, fluid conduits including air ducts, spoilers, grill-guards, running boards, brackets and pedals, wheels, vehicle frames, spoilers, housings including electrical and engine covers; (vi) industrial/consumer goods/products and parts including drills, files, knives, saws, blades, sharpening devices and other cutting, polishing and grinding tools, frames, hinges; (vii) molds and molding tools and equipment; (viii) aerospace parts and components including access covers, structural spars and ribs, propellers, rotors, rotor blades, rudders, covers, housings, fuselage parts, nose cones, landing gear, lightweight cabin parts, ducts and interior panels; and (ix) military products including ammunition, armor as well as firearm components, and the liken that are coated with fine-grained and/or amorphous metallic layers that are stiff, lightweight, resistant to abrasion, resistant to permanent deformation, do not splinter when cracked or broken and are able to withstand thermal cycling without degradation.

It is an objective of this invention to at least partially coat the inner or outer surface of parts including complex shapes with fine-grained and/or amorphous metallic materials that are strong, lightweight, have high stiffness (e.g. resistance to deflection and higher natural frequencies of vibration) and are able to withstand thermal cycling without degradation.

It is an objective of this invention to provide articles composed of fine-grained and/or amorphous metallic, Co-bearing Ni-free and Cu-free coatings, containing at least 50% per weight of Co, 0 to 35% per weight of Cr, 0 to 25% per weight of W, 0 to 25% per weight of P, 0 to 25% per weight of Mo, and 0 to 5% per weight of B.

It is an objective of this invention to provide articles composed of fine-grained and/or amorphous metallic, Ni-free and Cu-free Co-bearing coatings, containing between 1 and 35% Cr and/or 1-10% Mo.

Accordingly, to the invention is directed to a metal-coated polymer article as follows: an article comprising:

(i) a polymer substrate material; and
(ii) at least one metallic layer and/or patch on at least part of the outer surface of said polymer substrate material or on an intermediate structure thereon, said at least one metallic layer or patch is free of Cu and Ni and comprises at least 50% per weight of Co, 0 to 35% per weight of chromium, 0 to 25% per weight of tungsten, 0 to 25% per weight of phosphorus, 0 to 25% per weight of molybdenum, and 0 to 5% per weight of boron, wherein said at least one metallic layer or patch has a microstructure which is fine-grained with an average grain size between 2 and 5,000 nm and/or amorphous,
(iii) wherein said article is with or without said intermediate structure between said substrate material and the at least one metallic layer and/or patch comprising Co, wherein, when present, said intermediate structure comprises Co and is free of Cu and Ni, and has a layer thickness of less than 5 microns; and
wherein said article surpasses 6 hours without failure on the ASTM B368 CASS test.

The following listing further defines the laminate article/metal-clad article of the invention:

### Polymeric Substrate Specification

Polymeric materials comprise at least one of: unfilled or filled epoxy, phenolic or melamine resins, polyester resins, urea resins; thermoplastic polymers such as thermoplastic polyolefins (TPOs) including polyethylene (PE) and polypropylene (PP); polyamides, mineral filled polyamide resin composites; polyphthalamides, polyphtalates, polystyrene, polysulfone, polyimides; neoprenes; polybutadienes; polyisoprenes; butadiene-styrene copolymers; poly-ether-ether-ketone (PEEK); poly-aryl ether ketones (PAEK), poly ether ketones (PEK), poly ether ketone ketones (PEKK); polycarbonates; polyesters; self-reinforcing polyphenylenes; poly-aryl amides (PARA); liquid crystal polymers such as partially crystalline aromatic polyesters based on p-hydroxybenzoic acid and related monomers; polycarbonates; acrylonitrile-butadiene-styrene (ABS); chlorinated polymers such polyvinyl chloride (PVC); and fluorinated polymers such as polytetrafluoroethylene (PTFE). Polymers can be crystalline, semi-crystalline or amorphous.

Filler additions: metals (Ag, Al, Cr, In, Mg, Mn, Mo, Si, Sn, Pt, Ti, V, W, Zn); metal oxides (Ag₂O, Al₂O₃, MnOₓ, SiO₂, SnO₂, TiO₂, ZnO); carbides of B, Cr, Bi, Si, W; carbon (carbon, carbon fibers, carbon nanotubes, diamond, graphite, graphite fibers); glass; glass fibers; fiberglass metallized fibers such as metal coated glass fibers; mineral/ceramic fillers such as talc, calcium silicate, silica, calcium carbonate, alumina, titanium dioxide, ferrite, mica and mixed silicates (e.g. bentonite or pumice).

Minimum particulate/fiber fraction [% by volume or weight]: 0; 1; 2.5, 5; 10
Maximum particulate/fiber fraction [% by volume or weight]: 50; 75; 95

### Metallic Coating/Metallic Layer Specification

Microstructure: Amorphous or crystalline
Minimum average grain size [nm]: 2; 5; 10
Maximum average grain size [nm]: 100; 500; 1,000; 5,000; 10,000
Minimum hardness [VHN]: 100; 200; 400; 500
Maximum hardness [VHN]: 2,000; 3,000; 4,000
Metallic layer Thickness Minimum [μm]: 10; 25; 30; 50; 100
Metallic layer Thickness Maximum [mm]: 5; 25; 50
Metallic materials comprising at least one of: Ag, Al, Au, Co, Cr, Fe, Mn, Mo, Pd, Pt, Rh, Ru, Si, Sn, Ti, W, Zn and Zr
Other alloying additions: B, C, H, O, P and S
Particulate additions: metals (Ag, Al, Cr, In, Mg, Mn, Mo, Si, Sn, Pt, Ti, V, W, Zn); metal oxides (Ag₂O, Al₂O₃, MnOₓ, SiO₂, SnO₂, TiO₂, ZnO); carbides of B, Cr, Bi, Si, W; carbon (carbon nanotubes, diamond, graphite, graphite fibers); glass; polymer materials (PTFE, PVC, PE, PP, ABS, epoxy resins).
Minimum particulate fraction [% by volume]: 0; 1; 5; 10
Maximum particulate fraction [% by volume]: 50; 75; 95

### Intermediate Layer/Structure Specification

Intermediate layer(s) comprise at least one of a metallic layer, an oxide layer, and/or a polymer layer:
(i) Metallic Layer: composition selected from metallic materials list set forth above, including electroless Co and/or Ag comprising coatings, free of Ni and Cu; metallic layers can contain an oxide layer, or a sulfide layer on the outer surface, which can promote the bond strength to the polymer substrate.
(ii) Oxide layer: oxides of elements as listed in the metallic materials list, including Co and/or Ag oxides and sulfides and free of Ni and Cu.
(iii) Polymeric Layer: the polymer layer can be conductive (comprising Co for subsequent plating) or adhesive (for subsequent bonding to a prefabricated metal layer) and the polymer composition can be selected from the polymeric materials list above including partly cured layers prior to coating and prior to a finishing heat treatment, and furthermore cured polymeric paints (conductive paints: carbon, graphite, Ag- and/or Co-filled curable polymers, or adhesive paint layer(s)) and free of Ni and Cu.

### Intermediate Layer Thickness Minimum [μm]: 0.005; 0.025; 0.5;

### Intermediate Layer Thickness Maximum [μm]: 1; 2.5; 5; 25; 50

### Metal-Clad Polymer Article Specification

Adhesion

Minimum pull-off strength of the coating according to ASTM D4541-02 Method A-E [psi]: 200; 500; 1,000; 1,100; 1,200; 1,300; 1,350; 1,400.

Maximum pull-off strength of the coating according to ASTM D4541-02 Method A-E [psi]: 2,500; 3,000; 6,000.

Thermal Cycling Performance

Minimum thermal cycling performance according to ASTM B553-71: 1 cycle according to service condition 1 without failure (no blistering, delamination or <2% displacement) and with <2% displacement between the polymer and metallic material layers.
Maximum thermal cycling performance according to ASTM B553-71: infinite number of cycles according to service condition 4 without failure.

Corrosion Performance

Minimum Salt Spray performance according to ASTM B117: 48 hrs; 72 hrs; 96 hrs without failure (blistering, delamination, corrosion products on surface)
Maximum Salt spray performance according to ASTM B117: 960 hrs; 4,800 hrs; 9,600 hrs, infinite, without failure (blistering, delamination, corrosion products on surface)
Minimum CASS test performance according to ASTM B368: 6 hrs; 12 hrs; 24 hrs without failure (blistering, delamination, corrosion products on surface)
Maximum CASS test performance according to ASTM B368: 96 hrs; 480 hrs; 960 hrs; infinite; without failure (blistering, delamination, corrosion products on surface).

### Metal-Clad Polymer Article Mechanical Properties

Polymer substrate weight fraction of the metal-clad polymer article [%]: 5 to 95
Minimum yield strength of the metal-clad polymer article [MPa]: 5; 10; 25; 100
Maximum yield strength of the metal-clad polymer article [MPa]: 5,000; 7,500.
Minimum ultimate tensile strength of the metal-clad polymer article [MPa]: 5; 25; 100.
Maximum ultimate tensile strength of the metal-clad polymer article [MPa]: 5,000; 7,500.

### Adhesion Test Specification

ASTM D4541-02 “Standard Test Method for Pull-Off Strength of Coatings Using Portable Adhesion Testers” is a test for evaluating the pull-off strength of a coating on rigid substrates determining the greatest perpendicular force (in tension) that a coating/substrate interface surface area can bear before it detaches either by cohesive or adhesive failure. This test method maximizes tensile stress as compared to shear stress applied by other methods, such as scratch or knife adhesion and the results may not be comparable. ASTM D4541-02 specifies five instrument types identified as test Methods A-E and the pull off strength reported is an average of at least three individual measurements.

### Thermal Cycling Test Specification

ANSI/ASTM specification B604-75 section 5.4 Test (Standard Recommended Practice for Thermal Cycling Test for Evaluation of Electroplated Plastics ASTM B553-71). In this test the samples are subjected to a thermal cycle procedure as indicated in Table 1. In each cycle the sample is held at the high temperature for an hour, cooled to room temperature and held at room temperature for an hour and subsequently cooled to the low temperature limit and maintained there for an hour.

TABLE 1
Standard Recommended Practice for Thermal Cycling Test for
Evaluation of Electroplated Plastics According to ASTM B553-71.

| Service Condition | High Limit [° C.] | Low Limit [° C.] |
|---|---|---|
| 1 (mild) | 60 | −30 |
| 2 (moderate) | 75 | −30 |
| 3 (severe) | 85 | −30 |
| 4 (very severe) | 85 | −40 |

If any blistering, delamination or cracking is noted the test is immediately suspended. After 10 such test cycles the sample is allowed to cool to room temperature, is carefully checked for delamination, blistering and cracking and the total displacement of the coating relative to the substrate is determined.

### CASS Testing Specification

Copper Accelerated Salt Spray Testing Specification ASTM B368-09, Standard Test Method for Copper-Accelerated Acetic Acid-Salt Spray (Fog) Testing. The CASS test is widely employed and is useful for specification acceptance, simulated service evaluation, manufacturing control, and research and development. It was developed specifically for use with decorative, electrodeposited Ni/Cr and Cu/Ni/Cr coatings. In this test, samples are subjected to a Cu ions laden salt fog and the samples are periodically examined for delamination, blistering cracking and corrosion products from the underlying layers (steel, aluminum, copper, zinc, etc.). Typical exposure hours range between 6 and 96 hours. In many automotive specifications, thermal cycling followed by CASS testing is also performed.

### BRIEF DESCRIPTION OF THE DRAWINGS

The invention will be better understood with reference to the attached drawings, in which:

FIG. 1A illustrates a cross-sectional view of a nanocrystalline Co outer layer and an electroless Co intermediate layer on a polymer substrate, according to one embodiment of the invention.

FIG. 1B schematically illustrates articles manufactured according to the invention.

FIG. 2A illustrates a sample of a prior art Cu and Ni containing coating before the CASS test.

FIG. 2B illustrates a sample of a Co-bearing, Cu- and Ni-free, coating, according to a preferred embodiment of the invention, before the CASS test.

FIG. 2C illustrates a sample of a prior art Cu and Ni containing coating after the CASS test.

FIG. 2D illustrates a sample of a Co-bearing, Cu- and Ni-free, coating, according to a preferred embodiment of the invention, after the CASS test.

FIG. 3A illustrates the prior art coated articles subjected to a bend test.

FIG. 3B illustrates the inventive articles subjected to a bend test.

### DETAILED DESCRIPTION

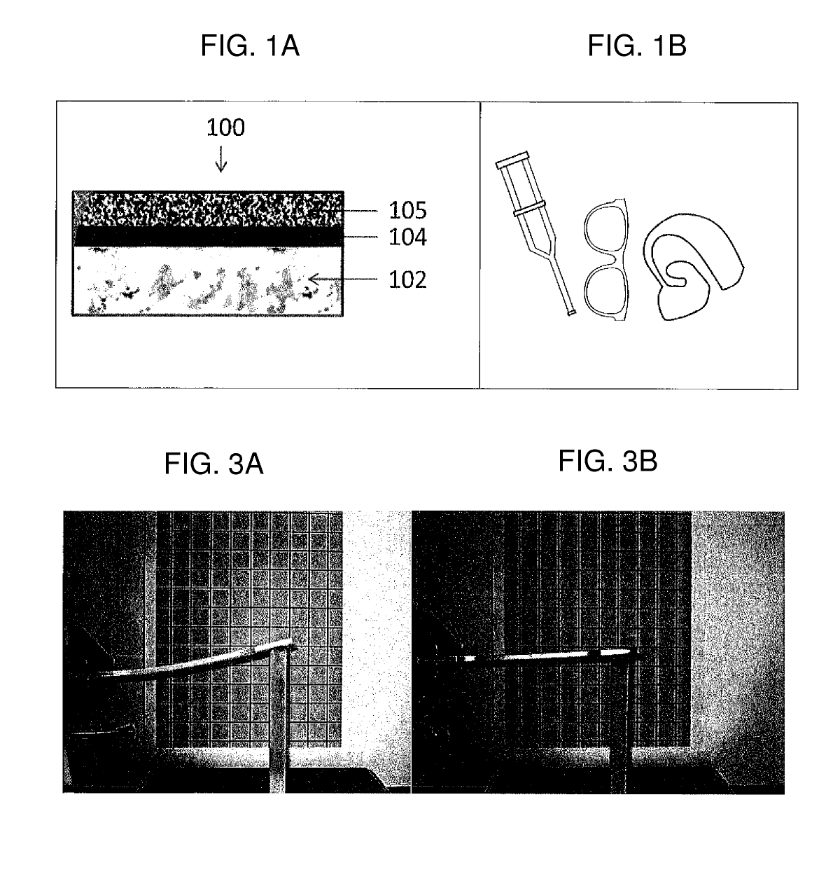

This invention relates to metal-polymer articles comprising Co-bearing Ni-free, Cu-free structural metallic material layers on polymeric substrates that are suitably shaped to form a precursor of the metal-clad polymer article. FIG. 1A illustrates a cross-section of the substrate and coating layers on a metal-polymer article manufactured through this invention. Referring to FIG. 1a the article 100 comprises a polymer substrate 102, a first layer 104 representing a metallized Co-bearing layer and a second layer 105 representing a fine-grained Co-bearing layer.

FIG. 1B shows outlines of typical articles that could be manufactured through this invention.

In particular, the invention relates to Co containing alloys for both metalization layer, as well as the structural/functional metallic layers, but can be applied to any Ni- and Cu-free alloy system. The metallic materials/coatings are fine-grained and/or amorphous and are produced by DC or pulse electrodeposition, electroless deposition, physical vapor deposition (PVD), chemical vapor deposition (CVD), and gas condensation or the like.

The person skilled in the art of metalization of polymeric substrates will know how to metalize suitable unfilled or filled polymeric substrates listed above. In broad terms the metalization process involves a series of steps, namely: etching, neutralization, noble metal catalytic seeding, catalyst reduction (acceleration) and electroless deposition. During the etching step the polymeric substrate is attacked by the etching medium, usually a strong oxidizing agent, thereby increasing the surface area, making the surface hydrophilic, and forming micro-pores on the surface providing the bonding sites for the metal to be deposited. Commonly used etchants include sulfuric-chromic acid, alkaline permanganates, and bifluorides, to name a few. After etching, the surfaces are thoroughly rinsed and immersed in a neutralizer solution, such as sodium bisulfite removing excess etchant from the polymer substrates. Following neutralization the polymeric substrates are immersed in an activator solution which contains a noble metal catalyst, which is seeded on to the polymeric substrate. Typical noble metal catalysts include palladium, platinum or gold, with the palladium-tin system being the most commonly used.

After the activation process, which embeds the metallic catalyst on the polymeric surface, the surface is treated with the accelerator, which removes the hydrolysis products around the metal catalyst particles, leaving the metal catalyst exposed to the electroless deposition process. The final process step in the metalization sequence is the electroless deposition process. The electroless metal deposition formulations consist of a semi-stable solution containing a metal salt, a reducer, a complexing agent for the metal, a stabilizer, and a buffer system. When idle, the bath is stable, but when a palladium bearing surface is in contact with the solution, a chemical reduction of metal occurs at the palladium sites and, through autocatalysis, the reduction reaction continues until the part is removed. For most applications, electroless Ni or electroless Cu baths are used for the primary function of rendering the surface of the polymer sufficiently electrically conductive to enable electrodeposition.

In one embodiment of the present invention, a Co-bearing Ni- and Cu-free electroless deposition process, with electroless Co as the metallization layer is used. A person skilled in the art of electroless deposition will know that Co can be electroless deposited on polymeric substrates from either alkaline or acidic formulations as indicated, e.g., in, U.S. Pat. No. 4,128,691 (1978) and US 2004/0096592. In the present invention, however, a novel electroless Co plating formulation and process has been developed capable of achieving high adhesion on engineered polymers that are not particularly easily platable with conventional electroless Ni or Co processes. The electroless Co plating bath composition used in the metalization of polymeric substrates is shown in Table 2.

TABLE 2
Preferred Formulations and Plating Conditions for
the Electroless Cobalt Plating Bath.

| Electroless Cobalt Plating Bath Constituents | Composition | |
|---|---|---|
| Cobalt Sulfate Heptahydrate | 10-20 | g/L |
| Cobalt Chloride Hexahydrate | 1-5 | g/L |
| Citrate Salts | 10-20 | g/L |
| Citric Acid | 6-15 | g/L |
| Sodium Hypophosphite | 16-30 | g/L |
| Stabilizer | 3-5 | ppm |
| Ammonium Hydroxide | 5-8 | ml/L |
| Electroless Cobalt Plating Parameters | Values | |
| Temperature | 45-67° | C. |
| Time | 15-20 | min |

| | |
|---|---|
| pH | 8.6-9.4 |

It was surprisingly determined that an important factor in achieving metalization with high adhesion on engineered polymers is the concentration of the citrate salts. It has been unexpectedly determined that the concentration of the citrate salt in the electroless Co plating bath can significantly affect the adhesion of the electroless Co layer on engineered polymers. The optimal citrate salt concentration needs to be ≧12 g/L, preferably in the range of between 12 and 16 g/L.

To further enhance the bond between the metallic layer, i.e., the metallizing/intermediate layer or the fine-grained/amorphous metallic layer and the polymer, polymeric surfaces forming the interface with the metallic layer are typically preconditioned before the metallic layers are applied. Bond strength depends upon a number of factors, such as, complexity of the surface features, the population, size and shape of the filler materials anchoring structures which affect the mechanical interlocking Bond strength may also be a function of chemical interactions, e.g., between functional surface groups of the polymers present or introduced during etching, contribute to the bond strengths as typically after etching the wetting angle is reduced due to the creation of hydrophilic functional groups, i.e., —COOH and —COH. Similarly, the metal surface at the interface can be at least partially oxidized which at times can enhance the adhesion.

Another process that can be used to improve the adhesion between the polymeric substrate and the metallic layer entails a suitable heat treatment of the metal-clad article for between 5 minutes and 50 hours at between 50 and 200° C.

In one embodiment of the invention the electroless Co metalization process is carried out in the absence of a palladium seed layer that is normally required for electroless deposition processes. Specifically, the electroless Co metalization layer is formed on cobalt-sulfide based seed particles and is palladium/noble-metal free.

In one embodiment of this invention, high strength Ni-free and Cu-free Co layers can be applied on to the electroless-Co metalized polymeric surface through an electroplating process which suitably coats the surface(s) to be coated with one or more layers of fine-grained and/or amorphous Co comprising metallic material(s). Surfaces not to be coated can be suitably masked using lacquers, rubber-based coatings, hard masks and tapes. The surface of the substrate to be plated can be shot peened using an abrasive material including glass bead, steel shot or aluminum oxide, optionally followed by alkaline cleaning or an electrolytic “electro-clean” process using DC or AC current.

Optionally, one or more thin layers called “intermediate conductive layers or structures” can be applied prior to applying one or more Co-bearing coatings of the invention by sputtering, thermal spraying, chemical vapor deposition, physical vapor deposition of by any two or more of these. The intermediate conductive layers or structures include metallic layer comprising Co—, Ag—, Zn—, Sn— or a combination of any two or more of these.

A person skilled in the art of plating will know how to generally electroplate selected fine-grained and/or amorphous metals, alloys or metal matrix composites choosing suitable plating bath formulations and plating conditions. Specifically to fine-grained and/or amorphous coatings comprising Co of this invention a number of process variables need to be closely controlled in order to achieve the desired properties outlined in this invention. In the case of tank plating, the part(s) to be plated are submerged into a Co-ion containing plating solution; providing one or more dimensionally stable anode(s) (DSA) or one or more soluble anode(s) and optionally one or more current thieve(s) and/or shield(s) submersed in the Co-ion bearing plating solution; providing for electrical connections to the cathode(s), current thieve(s) and anode(s) and applying direct and/or pulsed current to coat the surface of the part with a Co-bearing coating; removing the part from the tank, washing the part; optionally baking the plated part to reduce the risk of hydrogen embrittlement and/or heat treating the part to harden the substrate and/or the Co-bearing coating/layer; optionally polishing/buffing or roughening the surface and optionally applying other coatings, e.g., Cr based coatings such as Co—Cr—Mo alloy coatings, protective paints, hydrophobic polymer coatings or waxes, and biocompatible coatings including, but not limited to, hydroxyapatite based coatings.

Dimensionally stable anodes (DSA) or soluble anodes can be used. Suitable DSAs include platinized metal anodes, platinum clad niobium anodes, graphite or lead anodes or the like. Soluble anodes include Co metal or Co alloy rounds, chips, wires and the like, placed in suitable anode basket made out of, e.g., Ti, and preferably covered by suitable anode bags. Where possible, the use of soluble anodes is preferred as, unlike when using DSAs, Co-ions lost from the electrolyte through reduction to the coating on the cathode get replenished by Co rounds which are anodically dissolved. Further benefits of using soluble anodes include a substantial reduction in the cell voltage due to the potential difference between Co-oxidation and oxygen evolution and much simpler bath maintenance.

Specifically preferred Co-bearing electroplating solutions include one or more Co-bearing compounds including cobalt sulfate (CoSO₄.4H₂O, CoSO₄.7H₂O) cobalt chloride (CoCl₂.6H₂O) and cobalt carbonates (CoCO₃.H₂O; 2CoCO₃-3Co(OH)₂H₂O) with a preferred concentration range of Co⁺⁺ ion between 10 g/L (or mol/L) and 100 g/L (or mol/L). Other salts can be used as sources for the Co metal ions including, but not limited to, citrates and phosphates. The Co-ion bearing plating solution optionally contains P-ions, e.g., as phosphorous acid (H₃PO₃) and/or phosphate, e.g., as phosphoric acid (H₃PO₄), with a P concentration in the range of between 0.5 to 100 g/L or mol/L. Phosphites and phosphates may be added to the Co-bearing plating to enable the formation of Co—P alloy deposits to provide for the phosphate/phosphite equilibrium, and to maintain the pH value of the plating solution, e.g., as phosphoric acid, Co phosphate or sodium phosphate.

The Co-bearing electroplating solution also typically contains one or more additives selected from the group of surfactants, brighteners, grain-refiners, stress-relievers, salts to raise the ionic conductivity and pH adjusters. Stress-controlling agents and grain-refiners based on sulfur compounds such as sodium saccharin may be added in the range of 0 to 10 ell, to control the grain-size/hardness and the stress. Other suitable grain refiners/brighteners include borates and/or perborates in the concentration range of between 0 and 10 g/L of B. Sodium, potassium or other chlorides can be added to increase the ionic conductivity of the plating solution which may also act as stress relievers.

A preferred range for the pH value of the electroplating solution is between 0.9 and 4. The surface tension of the Co-ion plating solution having the above described composition may be in a preferred range of 30 to 100 dyne/cm. A preferred temperature range of the plating solution is 20 to 120° C.

When using soluble anodes Co-ion depletion is prevented by using Co rounds as soluble anodes, e.g., retained in Ti anode baskets, otherwise Co-ion depletion is prevented by suitable bath additions. The anode area is typically larger than the cathode area to be plated, preferably by between 10 and 100% greater, taking into account the total surface area of the Co-rounds or Co-chips contained in, e.g., the Ti-anode baskets.

After suitably contacting one or more anodes and one or more parts serving as cathode(s), direct or pulsed current (including the use of one or more cathodic pulses, and optionally anodic pulses and/or off times) is applied between the cathode(s) and the anode(s). A suitable duty cycle is in the range of 25% to 100%, preferably between 50 and 100% and suitable applied average cathodic current densities are in the range of 50 to 300 mA/cm², preferably between 100 and 200 mA/cm², This results in typical deposition rates of between 0.025 and 0.5 mm/h. Agitation rates can also be used to affect the microstructure and the deposit stress and suitable agitation rates range from about 0.01 to 10 liter per minute and effective cathode or anode area (L/(min·cm²) or from about 0.1 to 300 liter per minute and applied Ampere (L/(min·A). Anodic pulsing can be employed as well, e.g., to avoid edge effects and obtain a more uniform thickness distribution on parts with complex geometry and/or to control the grain size. The microstructure (crystalline or amorphous deposits) can furthermore be affected by a number of variables including, but not limited to, the bath chemistry, the electric wave forms, cathode surface flow conditions and bath temperature,

By using the electrodeposition process described, Co-comprising coatings can be produced which are ductile, free of cracks, and possess sufficient hardness and residual stress to meet wear and fatigue requirements for wear-resistant coatings. Preferred Co-comprising coatings comprise Co in the range of about 35 to 100 weight percent, preferably in the range of between 50 and 95 weight percent and more preferably in the range of between 70 and 95 weight percent; Cr in the range of about 0 to 35 weight percent, preferably in the range of between 5 and 30 weight percent; P in the range of about 0 to 25 weight percent, preferably in the range of between 1 and 15 weight percent; W in the range of about 0 to 25 weight percent, preferably in the range of between 1 and 15 weight percent; Mo in the range of about 0 to 25 weight percent, preferably in the range of between 1 and 15 weight percent; B in the range of about 0 to 10 weight percent, preferably in the range of between 1 and S weight percent. Embedded in the fine-grained and/or amorphous Co-comprising coating can be one or more particulates representing between 0-50% per volume of the total metal matrix composite. Where desired, Fe additions result in Co—Fe bearing alloys. Using the process described with Co salts and H₃PO₃ additions to the bath, a preferred. Co-comprising coating can be deposited onto any suitable metallized polymer substrate using DC or pulse plating with a composition of Co with 2±1% per weight of P and unavoidable impurities totaling less than 1% of the total coating weight with an average grain size in the 5-50 nm range and an internal deposit tensile stress of 15±5 ksi, and an as-deposited Vickers hardness of 570±40 VEIN, The coating can be applied to any desired thickness. Similarly fine-grained, amorphous, mixed fine-grained and amorphous metallic layers comprising various compositions including, but not limited to, Co—P, Co—P—B; Co—Fe, Co—Fe—P, Co—W, Co—W—P, Co—Cr, Co—Mo, and Co—Cr—Mo with and without the addition of particulates can be synthesized.

The following working examples illustrate the benefit of the invention.

### Example 1

### Pull Off Adhesion Strength Obtained on ABS and PEEK with an Electrolytic Co Coating Using Electroless Co as the Intermediate Layer

Representative ABS and PEEK test coupons, 2″×2″ in size were coated with electroless Co as the intermediate layer to a thickness of between 1-2 μm using the process conditions listed in Table 1 and the citrate salt additions as indicated in Table 3 followed by electrolytic Co to a thickness of about 30 μm using the process conditions listed in Table 4.

Another set of ABS and PEEK coupons was plated using conventional electroless Ni to a thickness of between 1-2 μm, followed by acid Cu to a thickness of around 20 μm and finally the sulfamate Ni process to a thickness of about 10 μm. Pull-off adhesion strength of the coatings on the samples was measured following ASTM D4541-02 using the “PosiTest AT Adhesion Tester” available from the DeFelsko Corporation of Ogdensburg, N.Y., USA and are depicted in Table 3. In all cases debonding occurred between the polymer material surface and the immediately adjacent metal layer. Pull-off strength exceeding 1,000 psi is considered “excellent” for structural metal-clad polymer parts.

TABLE 3
Pull-Off Strength According to ASTM D4541-02 for
Various Sample Specimen.

| | Pull-Off |
|---|---|
| | Strength |
| | ASTM |
| | D4541-02 |
| Sample type | [psi] |
| ABS Substrate + 1-2 μm conventional electroless | 940-1150 |
| Ni + 20 μm copper and 10 μm sulfamate Ni (prior art) | |
| PEEK Substrate + 1-2 μm conventional electroless | 860-1040 |
| Ni + 20 μm copper and 10 μm sulfamate Ni (prior art) | |
| ABS Substrate + 1-2 μm electroless Co with 12-16 g/L | 1450-1700 |
| citrate salts + 30 μm electrolytic Co (this invention) | |
| PEEK Substrate + 1-2 μm electroless Co with 12-16 g/L | 1350-1600 |
| citrate salts + 30 μm electrolytic Co (this invention) | |
| ABS Substrate + 1-2 μm electroless Co with >16 g/L citrate | 1210-1330 |
| salts + 30 μm electrolytic Co (this invention) | |
| PEEK Substrate + 1-2 μm electroless Co with >16 g/L | 1120-1240 |
| citrate salts + 30 μm electrolytic Co (this invention) | |

TABLE 4
Formulations and Plating Conditions for the Electrolytic Co Plating Bath.

| Parameter | Value |
|---|---|
| Boric Acid | 30-50 g/L |
| Cobalt Chloride Hexahydrate | 30-50 g/L |
| Organic Additives | 1-3 g/L |
| Cobalt Sulfate Tetrahydrate | 100-200 g/L |
| Temperature | 60° C.-70° C. |
| pH | 2.0-3.0 |
| Average Current Density | 33 mA/cm² |
| Duty Cycle | 70% |

It is apparent that the electroless Co solution as described with ≧12 g/L citrate salt addition, particularly in the range of between 12 and 16 g/L, yields the highest adhesion on both ABS and PEEK substrates.

### Example 2

### CASS Corrosion Performance for ABS Substrates Coated with Cu, Ni and Cr And ABS Substrates Coated with Electrolytic Co Using Electroless Co as an Intermediate Layer and Cr as the Top Coat, Providing a Ni-Free Cu-Free Solution for Biomedical Applications

ABS test coupons of size 4″×4″×0.1″ were obtained from SABIC Americas Inc. of Houston, Tex., USA. All the samples were rinsed in isopropanol, dried and degreased to remove any residual oils and/or films prior to metalization. An intermediate conductive layer of electroless Co having a thickness of between 1-2 μm was applied to all coupons using the process described in Example 1 with a citrate concentration of 15 g/L. The inventive samples were coated with a layer of electrolytic Co to a thickness of 30 μm using the process conditions listed in Table 4. The prior art samples contained an intermediate conductive layer of electroless Ni having a thickness of between 1-2 μm, electrodeposited Cu having a thickness of around 20 μm, and a trilayer Ni coating having a total thickness of around 30 μm. All samples were coated with Cr to a thickness of about 1 μm.

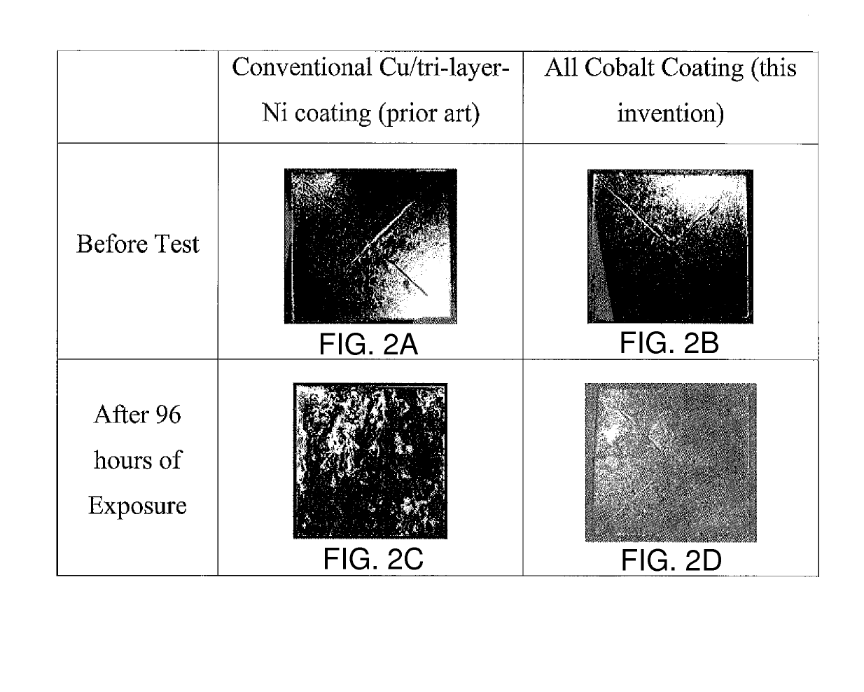

The coupons were tested for Copper Accelerated Acetic Acid (CASS) test alongside conventional tri-layer Ni coating with the results shown in FIGS. 2A-2D. All the coupons with an all-Co coating passed the test and showed no evidence of corrosion following 96 hours of exposure. In comparison, significant corrosion is seen on the Cu/trilayer-Ni coating. Therefore the inventive Ni-free and Cu-free all Co-bearing coating provides for an excellent alternative for applications where frequent skin contact occurs including, but not limited to, wheelchairs, crutches, canes, and walkers. CASS tests were also performed on selected prototype parts of some of these devices, having a layer of electroless Co, followed by electrolytic Co as illustrated in FIG. 1A. All Co coated samples tested passed the CASS test.

### Example 3

### Mechanical Property Comparison of PEEK Substrates Coated with Cu and Ni and PEEK Substrates Coated with a Ni-Free, Cu-Free Co-Bearing Coating Suitable for Use in Biomedical Surgical Tethers

The mechanical properties of the coating were measured using a three-point bend test evaluated using Instron 3365 testing machine. Tensile bars coupons molded in PEEK substrate (90HMF40 resin from Victrex) with a span of 7 cm, width of 1 cm and thickness of 0.5 mm were obtained from Vaupell Inc., MI. All the coupons were rinsed in isopropanol, dried and degreased to remove any residual oils and/or films following which they were coated with a 1-2 μm thick electroless Co layer and electrolytic Co to a thickness of 100 μm using the process described in Example 2. The results of the three-point bend test (performed as per ASTM D790-10) are given in Table 5 showing higher strength and stiffness of the hybrid structure compared to the bare polymer. The enhanced mechanical properties of Co on PEEK hybrids make it highly suitable for applications in surgical guidewires and catheters where buckling of the wires can be a problem. FIGS. 3A-3B show an in-test illustration of the enhanced stiffness obtained (a) for the bare PEEK substrate and (b) the PEEK substrate coated with a 1-2 μm thick layer of electroless Co and a 100 μm thick layer of electrolytic Co.

TABLE 5
Three-Point Bend Test Results According to ASTM D790-10) for
Various Sample Specimen.

| | Flexural | | Flexural |
|---|---|---|---|
| | Strength | Elongation at Break | Modulus |
| | [Mpa] | [%] | [Gpa] |
| Bare PEEK | 480 | 1.5 | 37 |
| PEEK + 1-2 μm | 570 | 1.5 | 46 |
| electroless Ni and 100 μm | | | |
| electrolytic Ni | | | |
| PEEK + 1-2 μm | 650 | 2 | 45 |
| electroless Co + 100 μm | | | |
| electrolytic Co | | | |

### VARIATIONS

The foregoing description of the invention has been presented describing certain operable and preferred embodiments. It is not intended that the invention should be so limited since variations and modifications thereof will be obvious to those skilled in the art, all of which are within the spirit and scope of the invention.

1. An article comprising:
(i) a polymer substrate material; and
(ii) at least one metallic layer and/or patch on at least part of an outer surface of said polymer substrate material or on an intermediate structure thereon, said at least one metallic layer or patch being substantially free of Cu and Ni and comprising at least 50% per weight of Co, 0 to 35% per weight of chromium, 0 to 25% per weight of tungsten, 0 to 25% per weight of phosphorus, 0 to 25% per weight of molybdenum, and 0 to 5% per weight of boron, and said at least one metallic layer or patch having a microstructure which is fine-grained with an average grain size between 2 and 5,000 nm and/or amorphous;
(iii) wherein said article is with or without an intermediate structure between said substrate material and the at least one metallic layer and/or patch comprising Co, said intermediate structure comprising Co and being substantially free of Cu and Ni with a layer thickness of less than 5 microns; and wherein said article is configured to surpass 6 hours without failure on the ASTM B368 CASS Test.

2. The article according to claim 1, wherein said article is configured to surpass 96 hours without failure on the ASTM B368 CASS Test.

3. The article according to claim 1, wherein said article is configured to surpass 48 hours without failure on the ASTM B117 Salt Spray Test.

4. The article according to claim 1, wherein said article has a minimum pull off strength according to ASTM D4541-02 of at least 1,350 psi.

5. The article according to claim 1, wherein said article exhibits no delamination after said article has been exposed to at least one temperature cycle according to ASTM B553-71 service condition 1, 2, 3 or 4.

6. The article of claim 1 wherein said metallic layer has a thickness between 5 μm and 2.5 mm.

7. The article according to claim 1, wherein the electrodeposited metallic layer and/or patch comprising Co contains particulate addition and said particulate addition is at least one material selected from the group consisting of: i) a metal selected from the group consisting of Ag, Al, Cr, In, Mg, Mo, Si, Sn, Pt, Ti, V, W, and Zn; ii) a metal oxide selected from the group consisting of Ag₂O, Al₂O₃, MnOₓ, SiO₂, SnO₂, TiO₂, and ZnO; iii) a carbide of B, Cr, Bi, Si, and W; iv) a carbon structure or material selected from the group consisting of carbon nanotubes, diamond, graphite, graphite fibers, ceramic, and glass; and v) a polymer material selected from the group consisting of PTFE, PVC, PE, PP, ABS, and epoxy resin.

8. The article according to claim 1, wherein the electrodeposited metallic layer and/or patch comprising Co has a hardness in the range of between 200 and 3,000 VHN.

9. The article according to claim 1, wherein the electrodeposited metallic layer and/or patch comprising Co represents between 1 and 95% of the total weight of the article.

10. The article according to claim 1 containing at least one polymer material selected from the group consisting of epoxy resins, phenolic resins, polyester resins, urea resins, melamine resins, thermoplastic polymers, polyolefins, polyethylenes, polypropylenes, polyamides, poly ether ketones, poly-ether-ether-ketones, poly-aryl ether ketones, poly ether ketone ketones, polyphthalamide, polyphtalates, polystyrene, polysulfone, polyimides, neoprenes, polyisoprenes, polybutadienes, polyisoprenes, polyurethanes, butadiene-styrene copolymers, chlorinated polymers including polyvinyl chloride, fluorinated polymers including polytetrafluoroethylene, polycarbonates, polyesters, polyphenylenes; poly-aryl amides, liquid crystal polymers, partially crystalline aromatic polyesters based on p-hydroxybenzoic acid, and acrylonitrile-butadiene-styrene, their copolymers and their blends.

11. The article according to claim 7 containing at least one filler addition selected from the group consisting of metals, metal oxides, carbides, carbon based materials, graphite fibers, glass, glass fibers, fiberglass, metallized fibers, and mineral/ceramic fillers.

12. The article according to claim 1, wherein said article is a component or part of an automotive, aerospace, consumer goods, sporting equipment, or medical application.

13. The article according to claim 12, wherein said article is a component or part selected from the group consisting of automotive cabin components, housings, orthopedic prosthesis, surgical tools, surgical scissors, surgical forceps, surgical needle holders, surgical hand-held and self-retaining retractors, surgical scalpels, surgical towel clamps, bone cutters, bone files and rasps, bone saw guides, surgical drill adaptors, surgical k-wires, guide wires, surgical nerve hooks, surgical pliers, surgical sleeves, surgical skin hooks, surgical suction tubes, surgical suture passers, surgical tension devices, orthopaedic surgical instruments, endosurgical devices, surgical staplers, surgical cutters, surgical staples, surgical splints, crutches, wheel chairs, crutches, hearing aid components, eyewear components, medical implants, golf shafts, drive shafts, golf club heads, hockey sticks, baseball bats, softball bats, tennis racquets, lacrosse sticks, hockey sticks, ski poles, walking poles, fishing rods, cell phones, smart phones, personal digital assistants devices, MP3 players, and digital cameras.

14. The article according to claim 1, wherein said metallic layer contains Co with between 1 and 15% P.

15. The article according to claim 14, wherein said metallic layer contains particulates.

16. The article according to claim 15, wherein said particulates are selected from the group consisting of diamond, SiC and BN.

17. The article according to claim 1, wherein said metallic layer contains between 1 and 35% Cr and 1 and 15% Mo having a microstructure which is fine-grained with an average grain size between 2 and 500 nm and/or amorphous.

18. The article according to claim 1, wherein said metallic layer and/or patch comprising Co has a layered structure.

19. The article according to claim 1 containing at least one intermediate layer comprising Co between said metallic material and said polymer material.

20. The article according to claim 1, wherein said metallic layer and/or patch comprising Co contains at least one element selected from the group consisting of Ag, Al, Au, Cr, Fe, Mn, Mo, Pd, Pt, Rh, Ru, Si, Sn, Ti, W, Zn, Zr, B, C, H, O, P and S.
